(19) United States
(12) Patent Application Publication
(10) Pub. No.: US 2023/0180748 A1
(43) Pub. Date: Jun. 15, 2023

(54) BIOACTIVE COMPOSITION FOR KILLING CELLS

(71) Applicant: AGXX Intellectual Property Holding GmbH, Berlin (DE)

(72) Inventors: Uwe Landau, Berlin (DE); Carsten Meyer, Berlin (DE); Olaf Wagner, Berlin (DE); Ayad Abul-Ella, Berlin (DE)

(73) Assignee: AGXX Intellectual Property Holding GmbH, Berlin (DE)

(21) Appl. No.: 17/926,583

(22) PCT Filed: May 26, 2021
(86) PCT No.: PCT/EP2021/064108

§ 371 Date: Nov. 28, 2022

(30) Foreign Application Priority Data
May 26, 2020 (EP) 20176476.8
Sep. 11, 2020 (EP) 20195684.4

(51) Int. Cl. A01N 25/34; A01N 59/16; A01P 1/00; A01N 25/26

(52) U.S. Cl. CPC A01N 25/34; A01N 59/16; A01P 1/00; A01N 25/26

(57) ABSTRACT

The invention relates to a bioactive composition for killing cells, comprising at least a first and a second half cell, the half cells being in electrically conductive contact with each other at least by their respective surfaces such that short-circuit elements are generated in the presence of water and oxygen. According to the invention the first half cell comprises at least one semiconductive compound of at least one transition metal element, which exhibits multiple oxidation states and allows a change of the oxidation states by means of catalytically active centers, so that oxygen is reduced and active oxygen species are produced at the first half cell, and wherein the second half cell comprises at least one electrically conductive silver semiconductor which absorbs electrons emitted by the cells or organic material. By means of particles coated with the composition according to the invention, for example, E. coli bacteria can be effectively and reliably killed with both a ruthenium oxide/silver chloride version (a-c) and a ruthenium oxide/silver sulfide version (d-f).

### BACKGROUND OF THE INVENTION

The invention relates to a bioactive composition for killing cells, comprising at least a first and a second half cell, the half cells being in electrically conductive contact with each other at least by their respective surfaces such that short-circuit elements are generated in the presence of water and oxygen. The invention further relates to the use of the bioactive composition and a method for producing the bioactive composition.

### PRIOR ART

The increasing resistance of clinically relevant bacteria to antibiotics and disinfectants, coupled with their ability to form biofilms, represents a serious problem in terms of effective and durable germ control in healthcare, industry and the home. The World Health Organization (WHO) is issuing increasingly urgent warnings of a dramatic antibiotic crisis. Bacterial infections that used to be easily controlled with antibiotics would then no longer be treatable. The search is therefore on for new antimicrobial solutions. The same resistance problem also applies to a lot of biocidal active ingredients. However, antimicrobial materials can help to prevent the colonization, growth and transfer of microorganisms on surfaces and thus make an important contribution to solving the antibiotic and biocide problem.

The oldest examples of antimicrobial materials are the so-called oligodynamic metals (e.g., silver, copper, zinc), which act by releasing metal ions. However, the antimicrobial effect of these materials in various environmental media is often limited by inhibition, e.g. by sulfur-containing compounds.

From WO 2008/046513 A2 a bioactive metallic coating containing silver, ruthenium and a vitamin is known, which is used for sterilization, disinfection and decontamination of water or aqueous solutions. The combination of silver with ruthenium and a vitamin, for example ascorbic acid, leads to faster and more efficient killing of microorganisms. At the same time, these bioactive metal surfaces prevent microorganism colonization and the attachment or stable deposition of problematic biomolecules such as DNA, RNA or proteins. The coating creates a self-cleaning surface which, when in contact with water or aqueous solutions, very quickly and efficiently establishes its sterility and maintains it over longer periods of time.

For a bioactive coating consisting of a metallic silver layer and a metallic ruthenium layer conditioned with a vitamin derivative, Guridi et al. (2015) postulate the following mechanism for the antimicrobial activity of the coating: microgalvanic cells on the silver/ruthenium surface generate an electric field that acts on the charged membranes of bacterial cells. At the ruthenium microcathodes of the galvanic cells, catalytically assisted redox reactions produce reactive oxygen species (ROS), e.g., diffusible molecules such as hydrogen peroxide, which kill the microorganisms and cause the formation of inhibition zones around appropriately coated meshes on agar plates. At the silver/silver chloride microanodes of the galvanic cells, the microorganisms are oxidized by the transfer of electrons from the microbes to the semiconductive anode surface.

Biocidal organometallic compounds, such as zinc pyrithione (ZnPT) or copper pyrithione (CuPT), are used in industry and medicine (e.g., ZnPT in hair shampoos), tributyltin (TBT) as an antifouling additive to boat paints, cisplatin (cis-diamminodichloroplatin) and tris (2,2′-bipyrazyl)ruthenium(II) (Ru[bipy]²⁺), which acts as a photosensitizer, to combat cancer. Because of their sometimes great toxicity, their use is highly regulated and, as in the case of tributyltin, largely banned. The frequently used triclosan is also threatened with a ban due to the suspicion of being carcinogenic.

Furthermore, metal oxides in combination with UV radiation and the addition of H₂O₂ are antimicrobially effective and are used industrially. Disadvantages of this method are that for its effectiveness electrical energy must be used for the UV lamps and H₂O₂ must be added consistently. In addition, UV irradiation is reduced in non-transparent liquids, which can lead to antimicrobial ineffectiveness of the system.

Another disadvantage is that the field of application is practically limited to use for water disinfection. UV lamps also have a limited service life, with system downtime and the sometimes costly conversion often significantly exceeding the pure lamp costs.

### SUMMARY OF THE INVENTION

It is the object of the invention to avoid the above-mentioned disadvantages of the prior art, especially in the use of UV lamps, and to provide a bioactive composition for killing cells that exhibits an efficient and long-lasting antimicrobial effect.

According to the invention, the object is achieved in that the first half cell comprises at least one semiconductive compound of at least one transition metal element, which exhibits multiple oxidation states (valences) and allows a change of the oxidation states by means of catalytically active centers, so that oxygen is reduced and active oxygen species are produced at the first half cell, and wherein the second half cell comprises at least one electrically conductive silver semiconductor which absorbs electrons emitted by the cells or organic material. Thus, the present invention advantageously comprises a bioactive material system comprising a semiconductive, catalytically active transition metal compound (half cell I of the galvanic element) and a semiconductive, hardly soluble silver compound (e.g., silver oxide, silver hydroxide, silver sulfide, silver-halogen compounds, or combinations thereof; half cell II of the galvanic element), wherein both are in direct, electrically conductive contact with each other. According to the invention, the transition metal element of the first half cell is selected such that it exhibits several oxidation states and thus permits a (relatively easy) change of oxidation states via catalytically active centers. Particularly suitable half cells are therefore those which have several valences and at which highly reversible redox reactions can take place over a wide potential range. The high catalytic activity of such half cells for oxygen reduction is due to the easy change of oxidation states and the easy exchange of oxygen, which preferentially take place at the active centers of the semiconductor surface. In this process, the transition metal element is only changed in its valence, resulting in the actual redox reaction. Therefore, no transition metal compound is consumed or formed, only the oxidation states are changed. The transition metal compound binds the molecular oxygen, allowing it to be catalytically reduced. Therefore, the presence of multiple valences is a prerequisite for the catalytic effect and the redox reaction. Thus, no transition metal compound needs to be formed. Special metal oxides or metal sulfides and hardly soluble silver compounds exhibit catalytic properties, electrical conductivity and high stability in water. By suitable combination of materials, two materials are in electrical contact with each other, which have different electrochemical potential and thus form a galvanic cell. If this cell is short-circuited by the aqueous phase, a high electric field strength is generated due to the small distance (nm and/or μm range) between the two contacting materials. This contributes significantly to germ elimination. Redox reactions take place at both electrodes of the microgalvanic element, each of which kills the microorganisms. At the first half cell (cathode), molecular oxygen is reduced to oxygen radicals, which then have a toxic effect on the microorganisms. At the second half cell (anode), electrons are transferred from the microorganisms to the silver semiconductor, thereby destroying them by oxidation.

The composition according to the invention, whose antimicrobial activity is not based on the release of biocides or metal ions but on the catalytically assisted generation of oxygen radicals, preferably on a noble metal combination of silver oxide/ruthenium oxide and/or silver chloride/ruthenium oxide, does not change its composition even during long-term antimicrobial use and, unlike biocides or oligodynamic metals, does not require a depot or devices regulating the biocide or metal ion release.

The two half cells can, for example, be applied as a layer system to surfaces of sheets, wires, fabrics or particulate carriers (“carriers”), wherein the coating of one material rests on top of the other material. In this case, the respective upper layer can be porously applied to or deposited on the other material, in particular in the form of a cluster, so that the aqueous solution or moisture has access to both half cells and the galvanic element is short-circuited. However, both materials can alternatively or additionally be mixed together as particles and/or applied to a surface so that they are in electrically conductive contact.

In a particularly advantageous embodiment of the invention, it is provided that the first half cell comprises cations of the transition metal element having different oxidation states. The first half cells used according to the invention, which are capable of electron transfer to oxygen (O₂), are semiconductors with deviations from the stoichiometric composition, which preferably comprise cations with different oxidation states at their surface. Particularly suitable half cells in this context are oxides, oxyhydrates, hydroxides, oxyhydroxides and/or sulfides of the transition metal elements, which can be present in several oxidation states, with which highly reversible redox reactions can occur over a large potential range, which have good electrical conductivity and which exhibit good chemical stability. For example, a metal oxide is only changed in valence, resulting in the actual redox reaction. Therefore, no oxide is consumed or formed, only the oxidation states are changed. The oxides bind the molecular oxygen, allowing it to be catalytically reduced. Therefore, the presence of several valences is a prerequisite for the catalytic effect and the redox reaction. Thus, no metal oxide has to be formed.

In a particularly advantageous embodiment of the invention, it is therefore provided that the transition metal compound of the first half cell comprises at least one metal oxide, metal oxyhydrate, metal hydroxide, metal oxyhydroxide and/or at least one metal sulfide of the transition metal element. Thus, the present invention advantageously comprises a bioactive material system which preferably consists of a semiconducting, catalytically active transition metal oxide or transition metal sulfide (half cell I of the galvanic element) and a semiconducting, hardly soluble silver compound (silver oxide, silver hydroxide, silver sulfide, silver-halogen compounds or combinations thereof; half cell II of the galvanic element).

The transition metal element of the semiconductive compound of the first half cell is preferably at least one metal selected from the group consisting of ruthenium, iridium, vanadium, manganese, nickel, iron, cobalt, cerium, molybdenum and tungsten. In an advantageous manner, vanadium oxides, nickel oxides, iron oxides, cobalt oxides, cerium oxides, molybdenum oxides and tungsten oxides are particularly suitable as transition metal element compounds, which are also referred to as supercapacitors (supercaps) due to their properties. They are also semiconductors.

In a particularly advantageous embodiment of the invention, it is therefore provided that the transition metal compound of the first half cell comprises ruthenium present in one or both of the oxidation states VI and IV. Ruthenium is a noble metal exhibiting multiple oxidation states and being capable of forming, for example, different ruthenium oxides due to its different valences. Surface redox transitions such as Ru(VIII)/Ru(VI), Ru(VI)/Ru(IV), Ru(IV)/Ru(III) and possibly Ru(III)/Ru(II) are the cause of the high catalytic activity of the mixed ruthenium compounds and their good electrical conductivities. The unusually distinctive catalytic and electrocatalytic properties of the ruthenium compounds depend on the variation of the oxidation states. For example, the antimicrobial activity is particularly high in compositions according to the invention that comprise ruthenium(VI) oxide in the first half cell.

The silver semiconductor of the second half cell preferably exhibits catalytic activity. For example, the interstitial silver ions in silver halogenide crystals react with trapped electrons and form silver clusters as the reaction proceeds. The sites where the electrons are trapped are the active sites in the silver halogenide crystal. The silver halogenide acts as a catalyst and is not consumed. If the silver reduced by electron trapping is anodically re-oxidized, then a cycling process results, but no silver ions are released from the silver halogenide crystal. Instead, all silver ions remain bound in the silver halogenide crystal.

In another advantageous embodiment of the invention, it is provided that the silver semiconductor of the second half cell is selected to have a low solubility in aqueous solutions and to be chemically stable to ingredients in the aqueous solution. For example, silver sulfide has the lowest solubility for the metal ion of all inorganic compounds in a wide pH range, so that the release of silver ions does not play a role in the antimicrobial activity for such a half cell.

The silver semiconductor of the second half cell may advantageously comprise at least one of silver oxide, silver hydroxide, silver halogenide, and/or silver sulfide. The silver semiconductor may also comprise, for example, a combination of silver and a corresponding silver compound (for example, metallic silver having on its surface a silver compound such as silver oxide or silver chloride).

In an advantageous embodiment of the invention, it is provided that sulfide anions are integrated into the semiconductor lattice of the silver halogenide (sulfide doping). For example, a redox process can thereby occur in the semiconductor lattice of the silver halogenide, so that no silver ions need to be released in order to be able to accept the electrons released by the cells. Sulfidic half cell systems preferred according to the invention are in particular silver sulfide or silver chloride/silver sulfide with nickel sulfide and/or molybdenum sulfide.

The bioactive composition according to the invention described above is preferably free of ascorbic acid.

The invention further relates to the use of the bioactive composition according to the invention described above for destroying/killing of microorganisms, viruses, spores, fibroblasts and/or cancer cells.

The object is also achieved by a method for producing the bioactive composition according to the invention as described above, wherein both half cells are applied onto at least one carrier material and/or onto each other, both half cells being applied such that they are, at least with their respective surfaces, in electrically conductive contact to each other.

Preferably, the first half cell is applied to the second half cell in the form of a porous (cluster-shaped) layer or the second half cell is applied to the first half cell in the form of a porous (cluster-shaped) layer. The two half cells can thus advantageously be applied as a layer system to surfaces, e.g., of sheets, wires, fabrics or particulate carriers, in such a way that they are in electrically conductive contact. In doing so, the upper layer can be applied to or deposited on the other material in a porous manner, in particular in the form of a cluster, so that aqueous solutions or ambient moisture have access to both half cells, thereby short-circuiting the galvanic element.

For example, the first half cell can be applied to the second half cell in layer thicknesses of 2 nm to 500 nm, preferably 10 to 100 nm.

In an advantageous embodiment of the invention, it is provided that the respective half cell is applied sequentially or simultaneously by means of electrochemical deposition, chemical-reductive deposition, electrophoretic coating, calcinating, PVD, CVD and/or sol-gel processes.

In calcination, thermally easily decomposable compounds containing the desired transition metals (usually anhydrous), e.g., in alcohols (e.g., ethanol or isopropanol), are intensively mixed, applied to the surface to be coated and then thermally decomposed at high temperatures (e.g., 200-500° C.) in the presence of air. In this process, any desired composition of the two half cell metals can be adjusted by mixing the two metal salts to obtain the appropriate oxidic compounds. Easily decomposable ruthenium compounds include, for example, RuCl₃ (halogenides in general).

In a particularly advantageous embodiment of the invention, it is further provided that the application of the first half cell comprises at least one step having a strong oxidative effect. For example, ruthenium/ruthenium oxides can be applied in a two-step process, wherein in the first step a re-oxidation of ruthenium initially occurs and only in the second step the reduction of the re-oxidized ruthenium to ruthenium and RuOx is accomplished. Unlike the direct, one-step reduction of Ru(III) ions by a strong reducing agent, this indirect, two-step process relies on the oxidation of Ru(III) ions to ruthenium(VIII) oxide (RuO₄). RuO₄ is a strong oxidizing agent that is converted to ruthenium(IV) oxide by suitable reducing agents, coating the substrate with a layer of ruthenium(IV) oxide. For example, the formation of ruthenium(VI) oxide can be achieved in both electrochemical and PVD deposition of ruthenium if the ruthenium deposition includes a process step with a strong oxidative effect.

In addition or alternatively, both half cells can be applied onto the surface of the carrier material in the form of single particles. These may be, for example, bimetallic particles comprising both metals and/or metal particles each comprising only one of the two metals. The latter can be applied to the carrier material sequentially, i.e., first particles of the first metal and then particles of the second metal (or vice versa), or simultaneously as a mixture of particles of both metals in such a way that they are in electrically conductive contact. The particles can be deposited on the carrier material in a single layer (lying side by side) and/or at least partially in multiple layers (lying on top of each other).

In an advantageous embodiment of the invention, it is further provided that the second half cell is converted into silver sulfide (Ag₂S) by a sulfidic treatment and/or that a metal sulfide of the first half cell is produced by sulfidic treatment of a metal oxide/hydroxide or a metal halogenide.

In another advantageous embodiment of the invention, it is provided that the silver semiconductor is converted into a silver halogenide by a reaction in a halogenide-containing aqueous solution (e.g., chloride solution).

In a further advantageous embodiment of the invention, it is provided that, after applying both half cells, a thermal post-treatment is accomplished for adjusting specific oxidation states. The deposited oxidic half cell coatings can be subjected to thermal oxidation or reduction in a suitable atmosphere to set specific oxidation states, provided that the substrate materials are thermally stable.

The two half cells can be applied, for example, to metals, glass or plastics and/or to carrier particles (e.g., glass particles, silver particles, plastic particles, nanoclay particles, cellulose fibers, carbon particles or zeolite powder). In doing so, individual half cell particles can be mixed together (e.g., by mortaring) in such a way that they are in electrically conductive contact with each other. The two half cells can, for example, be applied to the respective material as a microporous layer system or in the form of particles so that they are in electrically conductive contact.

In a particularly advantageous embodiment of the invention, it is further provided that the half cell particles are integrated into or applied to water- and oxygen-absorbing media such as sol-gels (e.g., siloxanes), creams, hydrogels, lacquers, paints, plasters, plastics (e.g., polyamides), and cellulose.

“Half cell” in the sense of the invention refers to a part of a galvanic element forming the latter in combination with at least one further half cell. In this context, a half cell comprises a metal electrode which is at least partially located in an electrolyte.

“Galvanic element” in the sense of the invention refers to the combination of two different metals, each of which forming an electrode (anode and cathode, respectively) in a common electrolyte. If the two metal electrodes are in direct contact with each other or are electrically conductively connected to each other via an electron conductor, the less noble metal with the lower redox potential (electron donor, anode) donates electrons to the more noble metal with the higher redox potential (electron acceptor, cathode) and subsequently initiates the redox processes at the electrodes.

“Electrolyte” in the sense of the invention refers to a substance (e.g., ions in aqueous solution) that conducts electric current under the influence of an electric field by the directional movement of ions.

“Metal” in the sense of the invention refers to atoms of a chemical element of the periodic table of elements (all elements that are not nonmetals) that form a metal lattice by means of metallic bonds and thereby form a macroscopically homogeneous material that is characterized, among other things, by high electrical conductivity and high thermal conductivity. The term “metal” also includes alloys comprising at least two different metals, metal compounds such as metal oxides, metal oxyhydrates, metal hydroxides, metal oxyhydroxides, metal halogenides and metal sulfides, and combinations of metals and corresponding metal compounds.

“Particle”, “particle-shaped” or “particulate” in the sense of the invention refers to individual particle-shaped bodies that are distinguished as a whole from other particles and their surroundings. In this context, all possible particle shapes and sizes, regardless of geometry and mass, are included within the scope of the invention. Particles may be characterized, for example, by their shape, weight, volume and/or size (e.g., length, diameter, circumference).

“Layer” or “layered” in the sense of the invention means a two- or three-dimensional structure that has a horizontal extension and is defined by at least two surfaces, the layer bottom and the layer top. In this context, a layer may comprise a coherent material or substance and/or particles that are at least partially in contact with each other. In the sense of the invention, a layer may be homogeneous, heterogeneous, continuous (i.e., uninterrupted), clustered, nanoporous, and/or microcracked. “Coated” in the sense of the invention is a material, particle or other body if at least a part of its (outer or inner) surface is provided with a “layer” (see above).

### DESCRIPTION OF PREFERRED AND EXEMPLARY EMBODIMENTS OF THE INVENTION

Metal Oxide or Metal Sulfide Half Cell I:

Many oxides of the subgroup metals show high electrocatalytic activity with respect to the evolution or reduction of oxygen or the oxidation of organic compounds. Metal oxides are semiconductors, some of which have good electrical conductivity. A non-stoichiometric composition of the oxide is essential for oxygen reduction. The electrocatalytic properties and electrical conductivity depend on the variation of oxidation states and the mobility of cations, especially near the surface. Reactive oxygen species adsorbed on solid surfaces are important intermediates at the liquid/solid phase interface, which is particularly true for some metal oxides. In the case of these metal oxides surfaces, they are responsible for their antimicrobial properties. For example, highly reactive superoxide anion species are formed by a catalytic process [Anpo 1999, 189]. For example, when molecular oxygen is in contact with the metal oxide surface, superoxide anion radicals (O²⁻) can be formed. The electrostatic contribution to the stabilization of the anion species on the positive ion at the surface plays a fundamental role [Pacchioni 1996]. Superoxide anion radicals are not the only intermediates formed on metal oxides, but also H₂O₂ and hydroxyl radicals OH* [Anpo 1999].

Oxides capable of electron transfer to oxygen (O₂) are in most cases semiconductors with deviations from the stoichiometric composition and have cations with different oxidation states at their metal oxide surface. Particularly suitable metal oxides for the bioactive metal oxide-silver semiconductor system according to the invention are transition metal oxides that can exist in several oxidation states, in which highly reversible redox reactions can take place over a wide potential range, that have good electrical conductivity, and that exhibit good chemical stability (e.g., ruthenium oxides, iridium oxides, vanadium oxides, manganese oxides, nickel oxides, iron oxides, cobalt oxides, cerium oxides, molybdenum oxides, and tungsten oxides). Because of these excellent properties, several of these metal oxides are used as electrode materials in so-called supercapacitors (supercaps). The high catalytic activity for oxygen reduction of these metal oxides is due to the easy change of oxidation states such as light oxygen exchange, which preferentially occur at the active centers of the surface. Most technically interesting metal oxide coatings, especially coherent oxide coatings on metals or on a semiconductor are amorphous, because only amorphous films can grow thick enough.

The reduction of molecular oxygen at transition metal surfaces with somewhat reduced oxides plays an important role in the complex redox reactions that can occur at the transition metal oxide surface. In order for the redox reactions and reduction of oxygen to reactive oxygen species (ROS) that can occur at the metal oxides to be sustained, the metal oxides must catalytically support the oxygen reduction and electrons must be supplied downstream. Surprisingly, this can be ensured by electrically coupling suitable catalytically active metal oxides or metal sulfides to silver semiconductor compounds. The electrical coupling creates a galvanic element in which electrons are delivered, for example, from the silver semiconductor electrode to the metal oxide surface by oxidation of the microorganisms. Transition metal semiconductors that have good electron conduction include some metal sulfides such as nickel sulfide (NiS) and molybdenum disulfide (MoS₂) with catalytic activity to form reactive oxygen compounds such as H₂O₂.

Silver Semiconductor Half Cell II:

The silver/silver sulfide phase boundary (Ag₂S) is formed by two phases with electron conduction. Ag₂S can be produced on a silver surface simply by immersion treatment in an aqueous solution containing sulfide, which can be easily followed by the dark coloration during immersion. Silver sulfide has the lowest solubility for the metal ion of all inorganic compounds in a wide pH range, so the delivery of silver ions, as in oligodynamic antimicrobial silver technology, plays no role in antimicrobial activity with this half cell. No ternary phases occur at the NiS/Ag₂S phase boundary, so the chemical potential of sulfur is in equilibrium with the Ag₂S. The two metal sulfides in electrically conducting contact have been shown to be a surprisingly effective bioactive layer system.

Molybdenum disulfide (MoS₂) is an electron conductor whose conductivity and catalytic activity to form reactive oxygen species increases upon exposure to light. Molybdenum disulfide is not soluble in water and dilute acids. Silver halogenides such as AgBr, AgCl, AgJ, in contrast to the alkali halogenides, have high covalent bonding fractions. This structural property, which is based on the high polarizability of the silver ion, is also responsible for the low solubility of silver halogenides (AgX) (AgCl>AgBr>AgJ>Ag₂S). Silver halogenides can be considered as intrinsic semiconductors with a distinct band structure. Normally, the conductivity of AgX is in the range of that of semiconductors. Because of the higher mobility of electrons, silver halogenides behave like n-type semiconductors. Silver halogenides (e.g., AgBr, AgCl, AgJ) are used e.g. in photography, but also for photolytic water decomposition.

In the real structure of the silver halogenide crystal, localized energy levels occur as a result of defects within the forbidden zone, i.e. in the energetic region between the valence and conduction bands. Depending on the energetic location, these can act as electron donors or acceptor traps. In addition, real silver halogenide crystals also exhibit structural disorder such as warps, steps, and dislocations. These play an important role in the formation of active sites in the silver halogenide crystal [Baetzold 2001]. The active sites in the silver halogenide crystal are crucial for the processes in photography and photolysis, among others. It is widely accepted that interstitial silver ions react with trapped electrons to form silver clusters. The electron is trapped at an excellent site (active site) on the surface. The interstitial silver ion migrates to the trapped electron. Further on, some larger silver clusters are formed by the same reactions. On silver bromide (AgBr is very similar to AgCl) it could be shown that e.g. the photo mechanism starts with an unstable silver atom. During the atomic lifetime, an electron can diffuse to the unstable atom and form a silver anion, which can subsequently neutralize an interstitial silver ion:

Ag⁻(in AgCl lattice)+Ag⁺(AgCl interstitial)→Ag₂(0)(in AgCl lattice)

In this way, the silver atom can capture electrons and subsequently become a dimeric silver [Baetzold 2001]. Sites where the electrons are captured are the active centers in the silver halogenide crystal. The silver halogenide acts as a catalyst and is not consumed. If the silver reduced by electron trapping is anodically re-oxidized, then a cycling process results. In this cycling process, no silver ions are released from the AgCl crystal. All silver ions are bound in the silver halogenide crystal. Ag₂S particles can be formed in the silver chloride lattice by sulfidic treatment, which also act as electron traps in the AgCl semiconductor and can additionally trap negative charges. This process would correspond to the model of the “Ag₂S ripening nucleus” in the explanation of the photographic elementary processes. According to this model, the AgCl/Ag₂S surface of the galvanic half cell, catalytically assisted, can also be used to accept electrons from microorganisms and oxidatively kill microorganisms.

The invention is explained in more detail in the following figures and examples.

### BRIEF DESCRIPTION OF THE FIGURES

FIG. 1 shows a photographic image of electrochemically prepared ruthenium oxide films on silver/silver chloride.

FIG. 2 shows photographic images of parts of two culture plates. For the determination of the antimicrobial efficiency of the ruthenium oxide layers on silver/silver chloride, a suspension culture with bacteria of E. coli (DSM 498, 10⁷/ml) was plated out with 50 μl. Then, the sample sheets were plated on a LB agar and incubated for 18 h at 37° C. The coated sample side is marked with an arrow.
a) (a) 10 cycles, (b) 25 cycles, (c) 50 cycles [arrow: all samples show a large inhibition zone];
b) (b) Ruthenium powder mixed with silver particles [no inhibition zone], (c) Ruthenium oxide powder* mixed with silver/silver chloride particles*** [large inhibition zone] (significant antimicrobial activity against 10 exp 7 E. coli (DSM 498) with 200 μl plated out on LB agar and incubated for 18 h at 37° C.).

FIG. 3 shows a photographic image of the part of a culture plate. A K₂S-treated, electrochemically prepared porous ruthenium oxide layer on a silver plate shows very high antimicrobial efficacy [very large inhibition zone which, despite partial one-sided coating (arrow), is edge-embracing and can be attributed to the formation of oxygen radicals]; (10 exp 7 E. coli (DSM 498) with 200 μl plated out on LB agar and incubated for 18 h at 37° C.).

FIG. 4 shows photographic images of parts of two culture plates. Antimicrobial activity of silver-coated glass beads (D=40 μm) electrolytically coated porously with ruthenium oxide, ruthenium electrolyte: ruthenium nitrosyl nitrate; post-treatment in chloride solution with formation of silver chloride of the silver surface of the glass beads accessible through the pores; (10 exp 7 E. coli (DSM 498) with 200 μl plated out on LB agar and incubated for 18 h at 37° C.). Post-treatment with K₂S and different ruthenium coating time (t), which takes significantly longer for the same coating thicknesses in the slow-depositing ruthenium nitrosyl nitrate electrolyte than in the ruthenium chloride electrolyte:

(a) sample 42, t=1 h; (b) sample 43, t=2 h; (c) sample 44, t=3 h; (d) sample 42, t=1 h, incubation in K₂S; (e) sample 43, t=2 h, incubation in K₂S; (f) sample 44, t=3 h, incubation in K₂S.

FIG. 5 shows photographic images of mouse fibroblasts. Biocidal effect of ruthenium oxide/silver chloride particles (D=40 μm) on adherent mouse cells: (a) start; (b) after 180 min (red coloration (not visible here in black/white) indicates killing of mouse fibroblasts).

FIG. 6 shows a photographic image of a culture plate. Antimicrobial efficiency of vanadium oxide layers on silver/silver chloride or silver/silver sulfide plates; 10 exp 7 E. coli (DSM 498) plated out with 200 μl on LB agar and incubated for 18 h at 37° C.):

b) Vanadium oxide on silver/silver chloride, 1 min coating time;

d) Vanadium oxide on silver/silver chloride, 10 min coating time;

f) Vanadium oxide on silver/silver chloride, 30 min coating time;

c) Vanadium oxide on silver, 1 min coating time, K₂S post-treatment;

e) Vanadium oxide on silver, 10 min coating time, K₂S post-treatment;

g) Vanadium oxide on silver, 30 min coating time, K₂S post-treatment.

FIG. 7 shows a photographic image of the portion of a culture plate. Antimicrobial activity of vanadium oxide silver/silver chloride glass beads (D=40 μm); 10 exp 7 E. coli (DSM 498) with 200 μl plated out on LB agar and incubated for 18 h at 37° C.).

FIG. 8 shows a photographic image of the portion of a culture plate. Antimicrobial activity of nickel oxide silver/silver chloride and nickel sulfide on silver/silver sulfide plate; 10 exp 7 E. coli (DSM 498) with 200 μl plated out on LB agar and incubated for 18 h at 37° C.).

Left: Nickel oxide silver/silver chloride: very low antimicrobial activity [very low inhibition zone];

Right: nickel sulfide-silver/silver sulfide: surprisingly strong antimicrobial activity [large inhibition zone].

FIG. 9 shows a current-time curve of silver and ruthenium when short-circuited in 0.1 M NaClO₄ and 0.01 M NaCl after incubation of the ruthenium electrode in 1% potassium sulfide solution for 30 minutes.

FIG. 10 shows photographic images of parts of two culture plates to illustrate the antimicrobial activity of powder mixtures; a) silver/ruthenium after incubation in K₂S; b) silver/ruthenium oxide after incubation in K₂S; c) silver sulfide/ruthenium after incubation in K₂S; d) silver sulfide/ruthenium oxide after incubation in K₂S; R) reference sample; ref. no. mB-003-2013.

FIG. 11 shows current-voltage curves for the reduction of the silver chloride layer formed for the electrode combination Ag/RuOₓ after incubation of the RuOₓ electrode in 1% K₂S; current-voltage curve vs. Ag/Ag⁺ (0.1 M), 10 mV/s; a) after 1 hour; b) after 2 hours; c) after 3 hours; d) after 4 hours.

FIG. 12 shows growth curves of MRSA bacteria using two ruthenium/ruthenium oxide//silver/silver chloride (Ru/RuOx//Ag/AgCl) powders (AP 383 and AP 823) prepared by different ruthenium deposition methods for different powder amounts.

FIG. 13 shows a photographic image of the part of a culture plate with a comparison of samples Ru (P01) and RuOx (P03) with respect to their antimicrobial activity. P01: PVD coated PE film (sample Ru) and P03: PVD oxidizing coated film (sample RuOx); both in 2-fold determination (LB agar, 3 days at 30° C.; suspension culture with bacteria of E. coli (DSM 498); 10 exp 8/m1 plated out with 200 micro liter).

FIG. 14 shows an XPS surface analysis (Ru3d spectra) of the electroplated Ru/RuOx//Ag/AgCl powder samples 825 and 392 and the Ru/RuOx//Ag/AgOx PVD coatings on polyethylene films (samples Ru and RuOx).

FIG. 15 shows O1s spectra for samples 825, 392, Ru, RuOx.

FIG. 16 shows growth curves of Ru/RuOx//Ag/AgCl powder (825, base silver particles) with (exposed) and without (unexposed) visible light irradiation.

### EXAMPLES

For all experiments at electrodes, pure silver sheets or silver coatings were chosen as coating substrates in order to exclude potentially interfering effects due to foreign metals.

### Example 1: Porous Ruthenium Oxide Layer on Silver/Silver Chloride

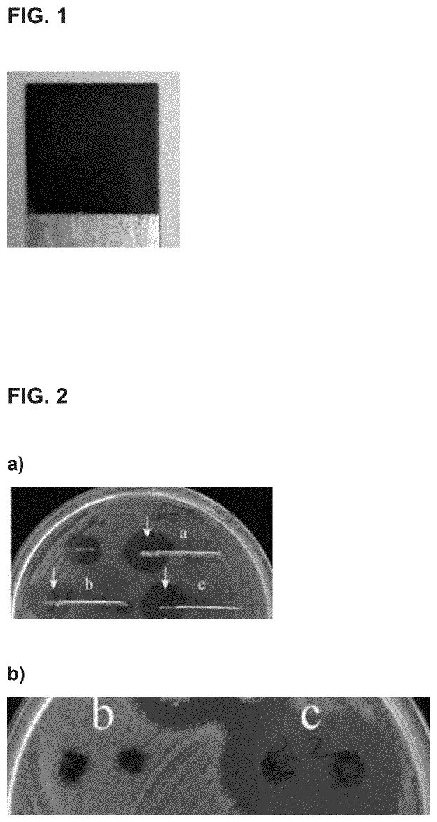

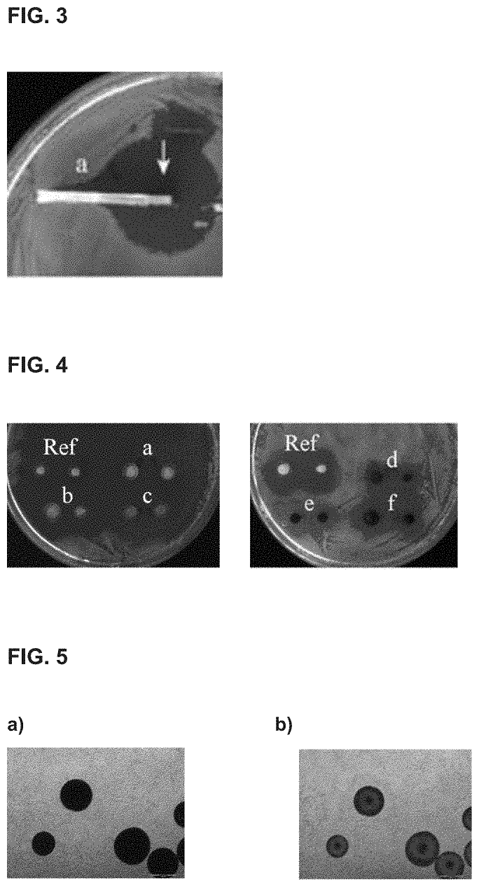

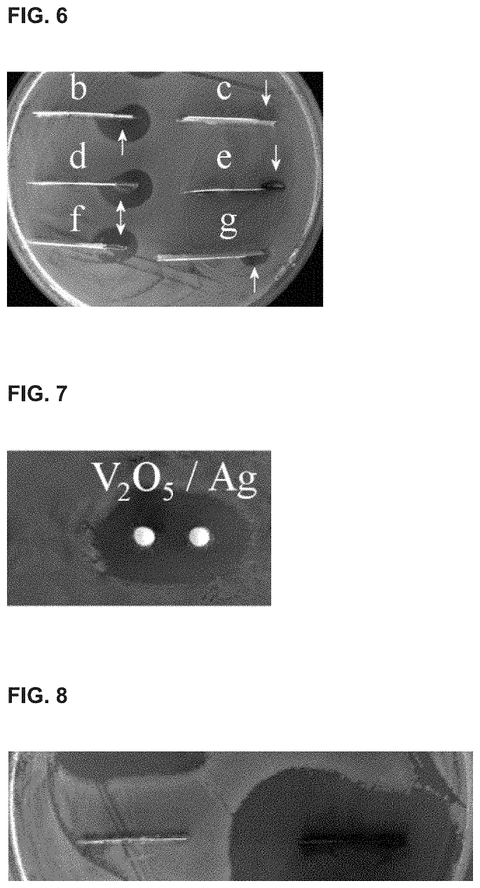

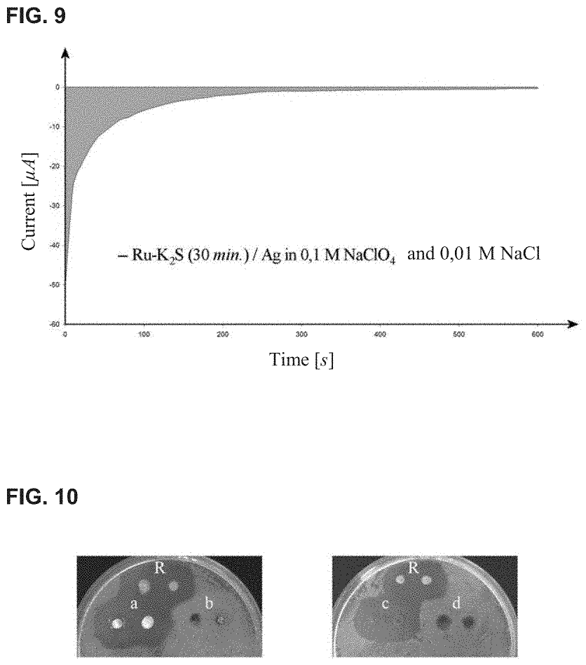

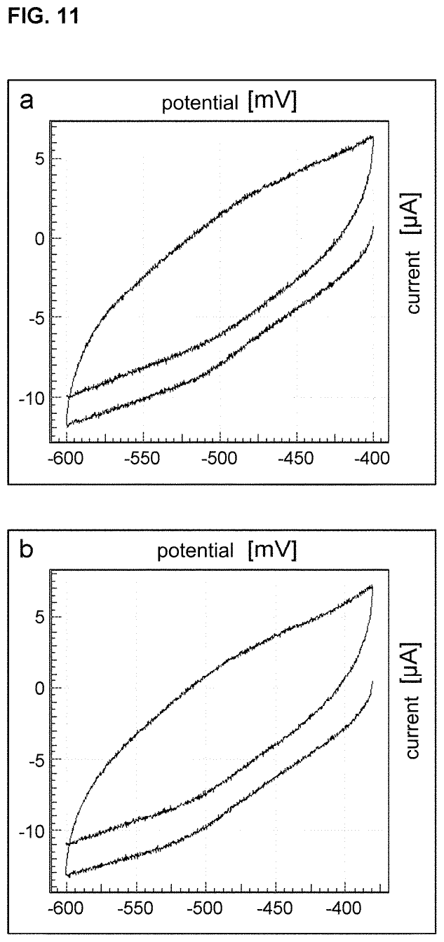

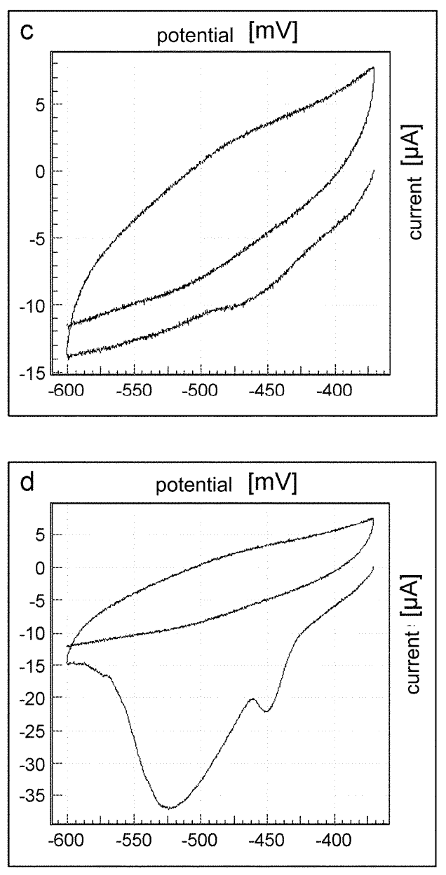

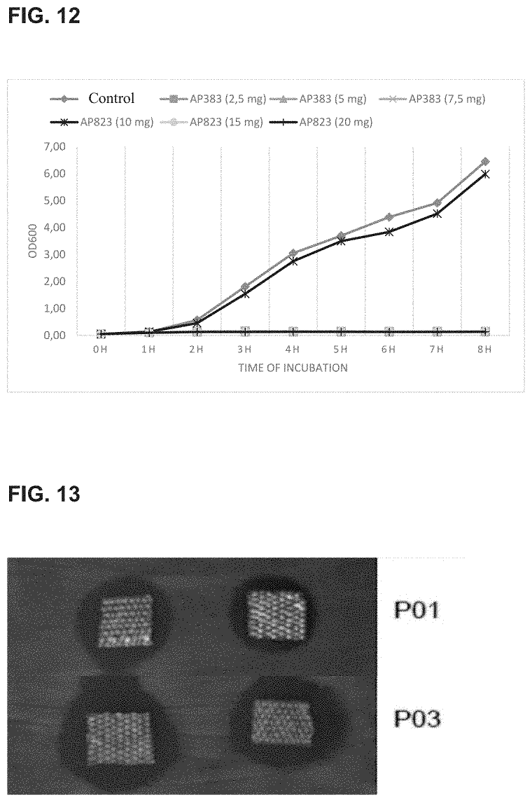

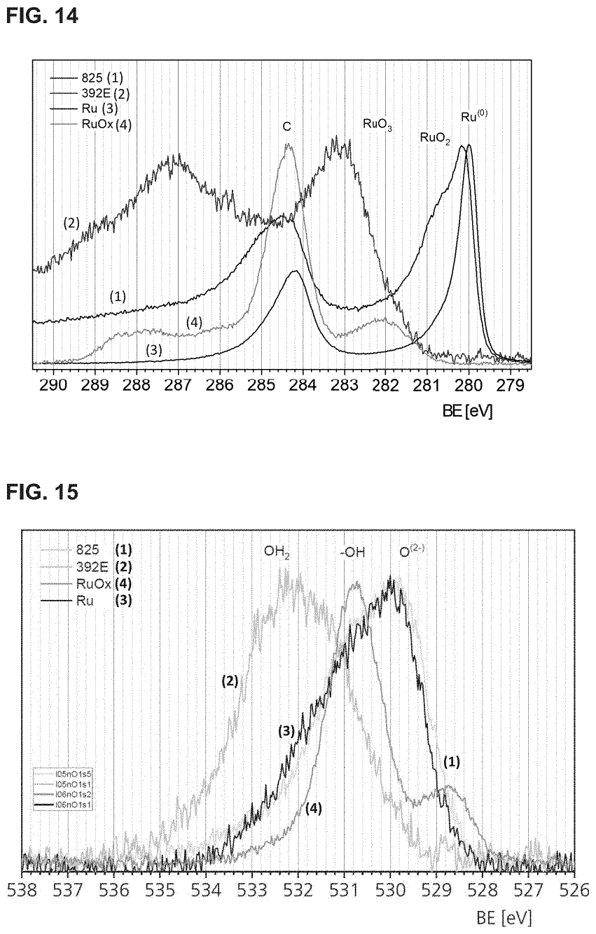

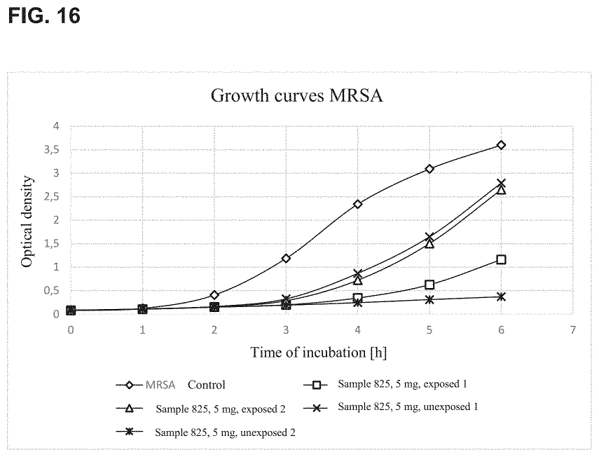

To investigate the antimicrobial activity of the microporous ruthenium oxide network on silver/silver chloride, hydrous ruthenium oxide was electrochemically deposited on silver sheet and the antimicrobial efficiency of the samples was investigated. All deposited layers of ruthenium oxide exhibit a dark, brown-gray color. FIG. 1 shows a ruthenium oxide layer after 10 cycles. XPS analyses showed that in the ruthenium oxide layers deposited electrochemically or chemically-reductively, the ruthenium was detectable in practically all oxidation states.

Deposition of ruthenium oxide layers on silver: Hydrous ruthenium oxide (RuOₓ-nH₂O) was deposited on silver sheet polished on one side (1.0 cm×2.5 cm). The coated area was 0.5 cm×1.0 cm in each case. The oxide layer was deposited by electrochemical cycling of the silver sheets in a potential range of 0 V to 0.84 V vs. NHE. The electrolyte used consisted of 0.005 M RuCl₃, 0.01 M HCl, and 0.1 M KCl at a temperature of 50° C. The deposition was performed in 10, 25, and 50 cycles. Since the ruthenium oxide layer was from an electrolyte containing chloride, the exposed silver surface was directly converted to silver chloride.

Very good antimicrobial activity was observed for all samples. Already for a coating duration of 10 cycles, an inhibition zone of maximum extension was formed (FIG. 2a (a)). Extending the coating time to 25 cycles (FIG. 2a (b)) or to 50 cycles (FIG. 2a (c)) did not result in any further increase in antimicrobial efficiency. Although the back of the samples had been masked off, a similarly high antimicrobial activity was observed there as on the coated side of the samples, which can be explained by the oxygen radicals formed and the microelectric field.

Surprisingly, a significant antimicrobial effect was also obtained by a mixture of ruthenium oxide with silver chloride particles.

FIG. 2b shows that ruthenium oxide powder*, mixed in a mortar with silver chloride coated small silver particles, form a large inhibition zone on the agar and thus show high antimicrobial activity (sample c). The same is true for ruthenium oxide hydroxide powder** (not shown in the picture). Surprisingly, pure ruthenium powder mixed with small silver particles shows no inhibition zone and thus no antimicrobial effect (sample b). This experiment demonstrates the importance of ruthenium oxide formation and semiconducting silver chloride for antimicrobial finishing.

[(*) Preparation of Ruthenium Oxide:

Ruthuna 478 solution is mixed with potassium hydroxide (10 g/l) and hydrogen peroxide (5%). The black precipitate is centrifuged off, washed several times with distilled water and ethanol and dried in a drying oven at 70° C.

(**) Production of Ruthenium Oxide Hydroxide:

Ruthuna 478 solution is mixed with potassium hydroxide (10 g/l) in a 1:1 ratio. After 1 week, the brown, flocculent precipitate is centrifuged off, washed several times with distilled water and ethanol, and dried in a drying oven at 70° C.]

### Example 2: Porous Ruthenium Oxide Layer on Silver/Silver Sulfide

The silver sulfide layer was formed on the silver electrode coated with porous ruthenium oxide network by immersion in a 1% potassium sulfide solution at room temperature for 5 min. A dark silver sulfide layer was formed on the silver sheet exposed under the ruthenium oxide network. The same result was also produced with a 30-minute immersion time, with only a darker coloration of the silver sulfide layer.

The ruthenium oxide-silver/silver sulfide surface showed that the antimicrobial efficiency of the sample was again significantly increased by the sulfide treatment after an electrochemical ruthenium oxide deposition period of 10 cycles (FIG. 3). The diameter of the inhibition zone approximately doubled compared to the ruthenium oxide/silver chloride surface. Due to the extremely low silver sulfide solubility (solubility product: 8×10 exp−51 (25° C.)), an effect of silver ions, as in an oligodynamic silver system, can be excluded.

The application of porous ruthenium oxide coatings can also be carried out electrolytically or chemically-reductively on particulate carriers, such as glass beads (D=40 μm). FIG. 4 shows the antimicrobial effect of silver-coated glass beads with ruthenium oxide coating, on which both silver chloride and silver sulfide have been formed in the silver-coated surface exposed through the microporous ruthenium oxide network. In this case, ruthenium nitrosyl nitrate served as the base for the chloride- and sulfide-free ruthenium electrolyte. Silver chloride was formed in the areas of the microporous deposition structure not covered with ruthenium oxide by post-treatment in a chloride solution. The silver sulfide was formed by a post-treatment with a 1% potassium sulfide solution at room temperature. As seen in FIG. 4, the E. coli bacteria are killed in both the ruthenium oxide/silver chloride variant (a-c) and the ruthenium oxide/silver sulfide variant (d-f). After incubation in chloride solution, the ruthenium oxide/silver chloride beads consistently exhibit very high antimicrobial efficiency (FIG. 4a-c). After incubation in potassium sulfide solution, it can be seen that the antimicrobial activity of the ruthenium oxide/silver sulfide system increases with increasing deposition time of ruthenium oxide (Fig. d→f).

The glass beads with the ruthenium oxide/silver chloride surface were also tested against mouse fibroblasts. As FIG. 5 shows, the glass beads coated with this semiconductor system also have high biocidal activity against adherent mouse fibroblasts, as indicated by the killed mouse fibroblasts appearing red in fluorescence microscopy.

### Example 3: Porous Vanadium Oxide Layer on Silver/Silver Chloride or Silver/Silver Sulfide

Vanadium oxide was electrochemically deposited on silver/silver chloride sheet. On a silver sheet (1.0 cm×2.5 cm), anodic deposition was performed at a current density of 1 mA/cm² NH₄V₃O₈−0.5 H₂O. The coated area was 0.5 cm×1.0 cm. Deposition was from a 0.15 M solution of ammonium metavanadate at a temperature of 50° C. The deposition time was 1, 10, 30 min, and 1 h, respectively. An orange-brown precipitate formed on the silver sheet. By annealing the samples for 24 h at 300° C., a uniform layer of vanadium oxide was formed. However, thicker layers of vanadium oxide detached from the silver substrate. This affected the two samples prepared with deposition times of 30 and 60 min. Nevertheless, the sample for a deposition duration of 30 min was examined for its antimicrobial activity. A very high antimicrobial efficiency can already be obtained for a deposition duration of 1 min (FIG. 6, samples b, d, f). The coated side is marked with an arrow. For a deposition time of 10 min, however, no further increase in antimicrobial activity is evident (FIG. 6, sample d). FIG. 6, sample f shows the antimicrobial activity of a sample after a deposition time of 30 min, although most of the coating had detached. Nevertheless, this sample has an undiminished high antimicrobial efficiency. Therefore, it can be assumed that even very thin layers of vanadium oxide on silver develop high antimicrobial activity. Further samples were additionally treated with 1% potassium sulfide solution for 5 min, so that a silver sulfide layer could form in the free spaces of the porous vanadium oxide network. The antimicrobial efficiency of the samples with silver/silver sulfide half cells are shown in FIG. 6, samples c, e, g. The coated side is marked with an arrow. Due to the formation of the silver sulfide layer on the sample coated with vanadium oxide for only 1 min, no inhibition zone was visible on the agar (FIG. 6, sample c). The longer deposition time produced thicker vanadium oxide layers, which showed antimicrobial activity (FIG. 6, samples e, g). Although in the case of the thicker vanadium oxide layer, part of the oxide layer flocculated after 30 min and only a thin vanadium oxide layer remained, this showed the largest inhibition zone of the vanadium oxide-silver/silver sulfide layers examined and thus a comparatively high antimicrobial activity after treatment with K₂S (FIG. 6, sample g). This result indicates the importance of the different oxidation states in the oxide layer. In the anodic deposition of the vanadium oxide layer, the electrode potential changes with increasing layer thickness in the case of galvanostatic operation, so that different oxidation states of the vanadium cation can form and thus also improve the catalytic properties.

Electrodeposition of porous vanadium oxide was also successfully performed on silver/silver chloride coated particulate carriers. The barrel plating method was used for the electrolytic coating of the silver-coated glass spheres with vanadium oxide. Anodic deposition of vanadium oxide from a 0.15 M solution of ammonium metavanadate at a voltage of 2.5 V was carried out for 15 min at a rotational speed of 340 rpm and an inclination angle of 70°. After sedimentation of the coated beads, the electrolyte was decanted and the coated glass beads were washed four times with 400 ml of distilled water. The beads were then annealed at a temperature of 300° C. for 24 h, during which vanadium oxide is formed. Light gray-brown beads are obtained, which have high antimicrobial activity. FIG. 7 shows the antimicrobial efficiency of the prepared glass beads.

### Example 4: Nickel Oxide or Nickel Sulfide-Silver/Silver Sulfide

After treatment of the silver sheets with nickel chloride (conc. NiCl₂*6 H₂O, 24 h immersion time, RT), no change in the silver sample surface can be observed optically. This means that under the deposition conditions described, only very thin nickel contamination of the silver surface has occurred. Therefore, only a very low antimicrobial activity of the sample can be detected, since little nickel oxide was formed (FIG. 8, left). The antimicrobial activity is significantly improved by depositing a thicker nickel oxide layer.

Interesting and unexpected, on the other hand, were the results with the sulfidic treatment of this layer system equipped only with nickel nuclei. After treatment with potassium sulfide, nickel sulfide forms on the nickel nuclei deposited on the silver surface. In the process, even in the free silver surface areas covered with silver chloride, the K₂S treatment replaces the silver chloride with the poorly soluble silver sulfide. Surprisingly, the nickel sulfide-silver/silver sulfide layer system shows a very high antimicrobial effect (FIG. 8, right).

### Example 5: Post-Treatment of the Semi-Elements with Sulfide Ions

The influence of sulfide ions on the ruthenium electrode was further investigated. The polished ruthenium electrode was therefore incubated for 30 min in 1% potassium sulfide solution. Subsequently, the ruthenium electrode was short-circuited against the silver electrode. The electrolyte used was 0.1 M sodium perchlorate and 0.01 M sodium chloride. Incubation of the ruthenium electrode in sulfide-containing solution shifts its potential so strongly into the negative potential range that the processes at the electrodes are reversed. Thus, oxidation occurs at the ruthenium electrode, whereas reduction occurs at the silver electrode. The altered electrochemical processes at the two electrodes also affect the antimicrobial efficiency.

A mixture of silver powder with ruthenium powder previously incubated in potassium sulfide solution shows undiminished antimicrobial activity (letter a in FIG. 10). In contrast, when the K₂S experiment is performed with ruthenium oxide powder mixed with untreated silver powder after K₂S treatment, no antimicrobial efficiency is evident (letter b in FIG. 10). Thus, the treatment of ruthenium oxide in potassium sulfide solution completely inhibits the antimicrobial activity of the sample mixture.

An identical picture emerges if, in addition to ruthenium or ruthenium oxide, the silver powder used was also previously incubated in potassium sulfide solution. A corresponding mixture of silver sulfide with K₂S treated ruthenium gives an antimicrobial effect (letter c in Fig.), while on the other hand the mixture of silver sulfide with K₂S treated ruthenium oxide has no antimicrobial properties. (letter d in FIG. 10)

On the one hand, the result confirms that the formation of silver sulfide does not have a detrimental effect on the antimicrobial properties of the sample mixtures. On the other hand, there is a difference between samples prepared with ruthenium and with ruthenium oxide. Apparently, ruthenium oxide and sulfide ions react to form a stable chemical compound that does not release antimicrobial substances when combined with silver. In addition to the loss of catalytic activity of the newly formed substance, the change in potential positions or reduced electrical conductivity could also play a role here. An explanation for the unabated high antimicrobial activity of the samples with sulfide-treated ruthenium powder is provided by the current-time curve shown in FIG. 9. After incubation of the ruthenium electrode in potassium sulfide solution, a thin covering layer of ruthenium sulfide has formed. Contact with silver oxidatively dissolves the top layer so that a catalytically active layer of ruthenium oxide can form again on the electrode surface and the electrochemical processes are finally reversed. According to FIG. 9, the current drops significantly within the first four minutes. Even after 10 min, there is no constant current. At this point, however, oxidation is still taking place at the ruthenium electrode. After 40 min, no current can be measured between the two electrodes. The anodic and cathodic processes at the electrodes cancel each other out. The polarity of the electrodes is then reversed, so that the silver electrode is now the anode, while reduction takes place again at the ruthenium electrode. The reaction of ruthenium with potassium sulfide is thus not irreversible, and after a short-circuit period of 4 hours an anodic current of 0.2 μA can again be measured at the silver electrode.

The reversal of the electrode processes can also be observed from the subsequent formation of silver chloride in the chloride-containing electrolyte at the silver electrode (FIG. 11). After a short-circuit period of 1 h (FIG. 11 a) and 2 h (FIG. 11 b), the formation of silver chloride is not yet detectable in the CV diagram. At this time, an anodic current is already measurable at the silver electrode, but it is very small. Only after 3 h is a small current wave of the reduction of silver chloride detectable (FIG. 11 c). After 4 h, however, a pronounced current signal for the silver chloride reduction is obtained in the CV diagram (FIG. 11 d).

### Example 6: Surprising Increase in Antimicrobial Efficacy by Ruthenium/Ruthenium Oxide Deposition after an Indirect, Two-Step Chemical-Reduction Deposition Process

Ruthenium can be deposited chemically-reductively with different strong reducing agents (e.g. NaBH₄, N₂H₄) in a direct, one-step way, for example on silver surfaces, and ruthenium/ruthenium oxides can be applied to the silver surface accordingly. However, ruthenium/ruthenium oxides can also be deposited in a two-step process, in which ruthenium is first oxidized in the first step and the oxidized ruthenium is reduced to ruthenium and ruthenium oxides only in the second step. It was expected that the different process routes for ruthenium/ruthenium oxide deposition on silver particles would lead to comparable antimicrobial efficacy. Surprisingly, however, the two-step process was found to have nearly an order of magnitude greater antimicrobial activity of the silver/silver oxide//ruthenium/ruthenium oxide against S. aureus (MRSA) and P. aeruginosa compared to the direct, one-step ruthenium deposition process. Unlike the direct, one-step reduction of Ru(III) ions by a strong reducing agent, the indirect, two-step process relies on the oxidation of Ru(III) ions to ruthenium(VIII) oxide [Chen 2011]. RuO₄ is a strong oxidizing agent that is converted to ruthenium(IV) oxide by suitable reducing agents, coating the substrate with a layer of ruthenium(IV) oxide. The oxidation of Ru(III) ions to RuO₄ is carried out by sodium hypochlorite. To stabilize RuO₄, the process is carried out in alkaline medium. The reduction to RuO₂ is carried out by sodium nitrite.

### Preparation of Semiconducting Silver/Silver Oxide//Ruthenium/Ruthenium Oxide Powders by Chemical Reductive Deposition of Ru/RuO_{X} on Silver Particles Using an Indirect, Two-Step Process for Ruthenium Deposition (AP 383):

50 g silver powder (Toyo Chemical Industrial, SBA10M27) was made into a slurry in a 2000 ml three-neck flask in an ultrasonic bath with 1000 ml deionized water. Additional agitation was performed with the KPG stirrer at 300 rpm. After 2 h, the brown suspension was transferred to another 2000 ml three-neck flask by decantation. In the ultrasonic bath and stirring with the KPG stirrer, 10 ml of Ru(NO)(NO₃)₃ solution (10.83 g/l) was added. Then a mixture of the following solutions was added to the suspension:

300 ml NaClO solution (14%),

100 ml NaOH solution (10 g/l),

87.5 ml NaNO₂ solution (10 g/l).

The silver powder immediately turned dark. The suspension was then stirred for 1 h in an ultrasonic bath. After sedimentation of the coated powder, the yellow supernatant was decanted off. The powder was taken up with deionized water and filtered off. After washing with deionized water, the powder was taken up with ethanol, filtered off and dried in a drying oven at a temperature of 60° C.

Antimicrobial Effect:

Surprisingly, silver/silver oxide//ruthenium/ruthenium oxide powders in which the ruthenium oxide was deposited chemically-reductively in a one-step and two-step process, respectively, show strikingly large differences in antimicrobial testing against MRSA bacteria (Gram-positive). Silver/silver oxide//ruthenium/ruthenium oxide powders (AP823) deposited by direct ruthenium reduction on silver particles using the strong reducing agent sodium borohydride (NaBH₄) exhibited antimicrobial activity nearly an order of magnitude lower than silver/silver oxide//ruthenium/ruthenium oxide powders (AP383) deposited by the two-step method. FIG. 12 shows the growth curves of MRSA bacteria in which the two ruthenium/ruthenium oxide//silver/silver oxide powders have been used with different amounts of powder. As can be seen from the shape of the growth curves, the two-step silver/silver oxide//ruthenium/ruthenium oxide powder (AP383) showed complete killing of MRSA bacteria at a weighed powder amount of 2.5 mg, whereas the one-step silver/silver oxide//ruthenium/ruthenium oxide powder (AP823) showed complete killing only at 15 mg powder amount. Thus, the 2-stage ruthenium deposition was found to have significantly increased antimicrobial efficacy compared to the 1-stage method, as indicated by the fact that complete germicide over the entire 8 h experimental period required only 2.5 mg of powder for sample 383 (equivalent Ru deposition method as 392) and >10 mg for sample 823, i.e., about 4-6 times less. A comparably large difference in antimicrobial activity (approx. one order of magnitude) was found in studies of the antimicrobial activity of both types of powder (AP823) and (AP383) against P. aeruginosa PA 14 (gram-negative).

The antimicrobial effect is particularly high for samples containing ruthenium (VI) oxide in the first half cell (Table 1). Apparently, the ruthenium (VI) oxide can be obtained in both electrochemical and PVD deposition of ruthenium when a process step with strong oxidative effect is present in the ruthenium deposition (392 and RuOx). The XPS surface analyses indicate a correlation between the antimicrobial effect and the composition of the ruthenium oxides, possibly depending on a certain ruthenium (VI) oxide/ruthenium (IV) oxide ratio. In any case, the presence of ruthenium (VI) oxide is beneficial or even necessary for the enhanced antimicrobial activity.

TABLE 1
XPS analysis results—manufacturing process-Antimicrobial efficacy

| | | | Chemical composition | | | |
|---|---|---|---|---|---|---|
| Sample | Basic | Ruthenium deposition | (XPS—3d spectra) * | | | Antimicrobial |
| designation | material | process | Ru(0) | RuO2 | RuO3 | efficacy |
| 825 | Silver | Chemical Reductive | 280, 1 eV | 280.7 eV | n.d. | |
| | particles | Direct Reduction | ++++ | ++++ | | ++ |
| 392/383 | Silver | Chemical—Reductive | Very low | Contained in | 282.9 eV | ++++ |
| | particles | 2-stage | share | the broad red | +++ | |
| | | Stage 1: Oxidation | + | peak RuO2 | | |
| | | Stage 2: Reduction | | (hydrated). | | |
| | | | | Substantial | | |
| | | | | part is RuO3 | | |
| | | | | ++ | | |
| “Ru” | PE film | PVD sputtering | 280.0 eV | Low | n.d. | ++ |
| | | | ++++ | proportion in | | |
| | | | | Ru(0) peak | | |
| | | | | + | | |
| “RuOx” | PE film | PVD Reactive | + | n.d. | 282, 1 eV | ++++ |
| | | Sputtering | | | ++++ | |
| | | (Oxidative) | | | | |

* Reference spectrum: silver (The binding energies of the high-resolution spectra were corrected using the Ag3d spectra.
Literature binding energies (eV):
Ru (0): Ru 3d: 280, 2 eV; J. F. Moulder, W. F. Stickle, P. E. Sobol and K. D. Bomben: Handbook of X Ray Photoelectron Spectroscopy: A reference of Standard Spectra for identification and interpretation of XPS Data, J. Chastain and J. R. C. King, Editors, p. 115, Physical Electronics Eden Prairie, Minnesota (1995).
RuO2: Ru 3d: 280, 66 eV; T. P. Luxton, M. J. Eick, K. G. Schekel; Journal of Colloid and Interface Science 359, (2011) 30-39.
RuO3: Ru 3d: 282, 5 eV; T. P. Luxton, M. J. Eick, K. G. Schekel ; Journal of Colloid and Interface Science 359, (2011) 30-39.
RuO3: Ru 3d: 282.4 eV; R. Kotz, H. J. Lewerenz and S. Stucki; J. Electrochem. Soc. 130, No. 4, 1983, 825-829.

### Example 7: Differences in Ru/RuOx//Ag/AgCl or AgOx Half Cell Combinations

In addition to the wet-chemical 2-step Ru deposition on silver, ruthenium and silver were also deposited by PVD coating on a PE foil, which has the advantage that no silver chloride is present on the PVD samples and any differences that may be detected can be attributed to the ruthenium half cell more unequivocally.
(A) PVD deposition:
   (a) Ruthenium sputtering on silver (sample designation “Ru”).
   (b) Reactive sputtering (O₂) of silver and ruthenium (sample designation “RuOx”).
(B) Chemical-reductive ruthenium deposition:
   (c) direct reduction for ruthenium deposition on silver (sample designation “825”).
   (d) Reduction of ruthenium to deposit on silver in the 2-step process already described (oxidation+subsequent reduction, (sample designation “392”).

These 4 samples were analyzed by growth curves and surface composition (XPS analysis). As a result, it has been shown that in both investigations differences occurred within the respective group (A) or (B), but also between groups (A) and (B), with an increased antimicrobial efficiency corresponding to a striking distinction in the surface composition, according to the XPS analysis.

FIG. 13 shows a comparison of the PVD-coated samples Ru (P01) and RuOₓ (P03) in the agar test with regard to their antimicrobial effect. As can be seen from the formation of the inhibition zone (double determination), the RuOx sample (P03) has a significantly greater antimicrobial effect against E. coli than the sample P01.

FIG. 14 shows XPS spectra of the samples Ru (a), RuOx (b) as well as 825 (c), 392 (d). Antimicrobial studies had shown, as described above, that there are significant differences in the chemical-reductive deposition and PVD deposition of Ru/RuOx//Ag/AgCl and AgOx half cell combinations, respectively. The XPS analyses show differences in a striking manner, which correspond to the different antimicrobial efficacies. As can be seen in the Ru3d spectra (FIG. 14), there are the following striking differences both in the group of chemically-reductively prepared samples 825 (c) (curve (1)), 392 (d) (curve (2)) and the group of PVD-coated samples Ru (a) (curve (3)), RuOx (b) (curve (4)) within one group and between the two groups:
A narrow signal from metallic ruthenium (BE=280.1 eV) is found in sample 825 (a) curve 1. The spectrum of sample Ru consists mostly (65%) of metallic ruthenium and about 24% is assigned to RuO₂.
The RuOx (b) sample (curve (4)—PVD oxidation sputtered) contains significantly less Ru(0), making the carbon components more prominent. The largest component (BE=284.4 eV) would be attributed to metal carbide (C apparently originates from PVD cleaning of the PE film). The ruthenium component of the spectrum is dominated by the signal at BE=282.1 eV, which accounts for about 85% and can be assigned to RuO₃**. The half-width of this component is quite large, so that a contribution of other compounds to the signal cannot be excluded. The remaining Ru components of the spectrum are caused by oxide hydrates of Ru(VI) or higher oxidation states of ruthenium.
Sample 392 (d) curve (2) is similar to sample RuOx (b) curve 4 and also contains RuO₃** in significant concentration. In addition, however, other compounds are present which may be oxide hydrates. But Ru compounds with greater valence are also possible. The Ru(0) and RuO₂ content is small. **) According to literature data (Table 1), between 282.2 eV and 282.6 eV RuO₃ is located.

In the oxygen O1s spectra (FIG. 15), one sees a grouping of the samples as described for the Ru3d spectra. The Ru and 825 samples give virtually identical spectra shapes, which can be matched with three components. Metal oxides are expected at BE=530 eV. The components at larger BE may represent hydroxides and hydrates. However, in all likelihood, significant portions of these are attributable to adsorbates. The RuOx sample is probably significantly influenced by the adsorbates. In addition, the O atoms can be seen in the ruthenium oxides. Sample 392 shows only small proportions of oxidic oxygen atoms. The predominant part is bound in hydrates. In between, hydroxides are probably still to be found.

### Example 8: Light has Virtually No Effect on Antimicrobial Efficacy

FIG. 16 shows the example of a sample (825), which is composed of two semiconducting half cells in powder form according to the invention, growth curves with and without light supply, whereby no differences in the antimicrobial efficacy with and without light supply can be seen within the limits of measurement accuracy. The differences in the growth curves at very low powder weights of 5 mg are not due to visible light irradiation, but to the measurement inaccuracy when weighing this very small amount of powder.

As shown in Example 5 and FIG. 10, ruthenium and silver powders treated differently with K₂S lead to different levels of antimicrobial activity in an electrically conductive half cell combination. Sulfide treatment (1% K₂S) of ruthenium powder as well as ruthenium oxide powder as the first half cell in combination with the second half cell of Ag/Ag₂S or Ag powders leads to completely different antimicrobial efficacy:
The combinations of the half cells RuOx/Sx//Ag as well as RuOx/Sx//Ag/Ag₂S show no antimicrobial effect at all.
The combination RuS₂//Ag and RuS₂//Ag/Ag₂S, on the other hand, exhibit very high antimicrobial efficacy.

Thus, although RuOx and RuS₂ are both semiconductors, it is surprising that sulfur addition renders only the ruthenium oxide semiconductor antimicrobially ineffective. Thus, it is not only the presence of a semiconductor that matters, but especially the formation of the single semiconductor half cell itself. On the other hand, Example 5 and FIG. 9 show by the example of a current-time curve that a RuS₂ half cell, brought into contact with the second half cell Ag/AgCl in an aqueous solution, changed its surface composition and regained antimicrobial effectiveness, indicating a complex interplay in the combination of two semiconductor half cells. The results of the different ruthenium deposition processes and the resulting different semiconductor compositions as well as the contact of short-circuited half cells with solution components, such as K₂S, and the resulting strong differences in terms of antimicrobial efficacy of the half cell combinations are a clear indication that, for example in the case of ruthenium, the design of the first half cell is important if high antimicrobial efficacy is required. The electrically conductive contact with the second half cell also leads to a change in the first ruthenium-containing semiconducting half cell that has a significant influence on the antimicrobial activity.

The XPS analyses show several differences in the oxidic composition of the samples studied. Striking, and possibly a main culprit for the increased antimicrobial efficacy, could be the presence of the hexavalent oxidation state of ruthenium, in addition to the RuO₂ and the metallic Ru(0), in the samples with high antimicrobial efficacy. In particular, in the PVD samples where AgCl is not present, there may be no influence from this side to increase the antimicrobial efficacy.

### LITERATURE

[Guridi 2015]: Guridi, A., Diederich, A.-K., Aguila-Arcos, S., Garcia-Moreno, M., Blasi, R., Broszat, M., Schmieder, W., Clauss-Lendzian, E., Sakinc-Gueler, T., Andrade, R., Alkorta, I., Meyer, C., Landau, U., and Grohmann, E.: Materials Science and Engineering C50 (2015) 1-11.
[Anpo 1999]: Anpo, M., Che, M., Fubini, B., Garrone, E., Giamello, E., and Paganini, M. C.: Topic in Catalysis 8 (1999) 189-198.
[Paccioni 1996]: Pacchioni, G., Ferrari, A., Giamello, E.: Chem. Phys. Lett. 255 (1996) 58.
[Baetzold 2001]: Baetzold, R. C.: J. Phys. Chem. B 2001, 105, 3577-3586.
[Chen 2011]: Jing-Yu Chen, Yu-Chi Hsieh, Li-Yeh Wang and Pu-Wie Wu: J. Electrochem. Soc., 158 (8) D 463-D468 (2011).

1. A bioactive composition for killing cells, comprising: at least a first and a second half cell, the first and second half cells being in electrically conductive contact with each other at least by their respective surfaces such that short-circuit elements are generated in the presence of water and oxygen, wherein
the first half cell comprises at least one semiconductive compound of at least one transition metal element, which exhibits multiple oxidation states and allows a change of the oxidation states via catalytically active centers, so that oxygen is reduced and active oxygen species are produced at the first half cell, and wherein
the second half cell comprises at least one electrically conductive silver semiconductor which absorbs electrons emitted by the cells to be killed or by organic material.

2. The bioactive composition according to claim 1, wherein the first half cell comprises cations of the transition metal element which have different oxidation states.

3. The bioactive composition according to claim 1 wherein the transition metal compound of the first half cell comprises at least one metal oxide, metal oxyhydrate, metal hydroxide, metal oxyhydroxide and/or at least one metal sulfide of the transition metal element.

4. The bioactive composition according to claim 1, wherein the transition metal element of the semiconductive compound of the first half cell is at least one metal selected from the group consisting of ruthenium, iridium, vanadium, manganese, nickel, iron, cobalt, cerium, molybdenum, and tungsten.

5. The bioactive composition according to claim 1, wherein the transition metal compound of the first half cell comprises ruthenium present in one or both oxidation states, VI and IV.

6. The bioactive composition according to claim 1, wherein the silver semiconductor of the second half cell exhibits catalytic activity.

7. The bioactive composition according to claim 1, wherein the silver semiconductor of the second half cell has a solubility in aqueous solutions so that a release of silver ions does not play a role in an antimicrobial activity for the half cell and is chemically stable to ingredients in the aqueous solution.

8. The bioactive composition according to claim 1, wherein the silver semiconductor of the second half cell comprises at least one silver oxide, silver hydroxide, silver halogenide and/or silver sulfide.

9. The bioactive composition according to claim 8, wherein sulfide anions are integrated into a semiconductor lattice of the silver halogenide.

10. A method for destroying/killing of microorganisms, viruses, spores, fibroblasts and/or cancer cells comprising
bringing the bioactive composition according to claim 1 in contact with the microorganisms, viruses, spores, fibroblasts and/or cancer cells in a microorganisms, viruses, spores, fibroblasts and/or cancer cells destroying/killing effective amount.

11. A method for producing the bioactive composition according to claim 1, wherein
both, the first and second, half cells are applied onto at least one carrier material and/or onto each other, wherein both, the first and second, half cells are applied such that they are, at least with their respective surfaces, in electrically conductive contact to each other.

12. The method according to claim 11, wherein the first half cell is applied to the second half cell in form of a porous layer or that the second half cell is applied to the first half cell in the form of a porous layer.

13. The method according to claim 11, wherein the first half cell is applied sequentially or simultaneously onto the second half cell, or vice versa, via electrochemical deposition, chemical-reductive deposition, electrophoretic coating, calcinating, PVD, CVD and/oder sol-gel processes.

14. The method according to claim 11, wherein application of the first half cell comprises at least one step that has a strong oxidative effect.

15. The method according to claim 11, wherein both, the first and second, half cells are applied onto a surface of the carrier material in form of single particles which are in electrically conductive contact to each other.

16. The method according to claim 11, wherein the second half cell is converted into silver sulfide (Ag₂S) by a sulfidic treatment and/or
a metal sulfide of the first half cell is produced by sulfidic treatment of a metal oxide/hydroxide or a metal halogenide.

17. The method according to claim 11, wherein the silver semiconductor is converted into a silver halogenide by a reaction in a halogenide-containing aqueous solution.

18. The method according to claim 11, wherein, after applying both, the first and second, half cells, a thermal post-treatment is applied for adjusting specific oxidation states.
